(19) United States
(12) Patent Application Publication
(10) Pub. No.: US 2003/0216998 A1
(43) Pub. Date: Nov. 20, 2003

(54) System and method for establishing and processing online transaction account based on awards resulting from transactions

(75) Inventors: Chia-Chi Chang, Taipei (TW); Cheng-Chi Chen, Taipei (TW); Hsin-Chieh Tsai, Taipei (TW)

Correspondence Address: TROXELL LAW OFFICE PLLC, SUITE 1404, 5205 LEESBURG PIKE, FALLS CHURCH, VA, 22041, US

(73) Assignee: NetBuck Payment Service Co., Ltd.

(21) Appl. No.: 10/147,877

(22) Filed: May 20, 2002

(51) Int. Cl. G06F 17/60

(52) U.S. Cl. 705/39

(57) ABSTRACT

The invention is to provide a data processing system and a method for establishing and processing an online transaction account based on transaction awards obtained by a person and offered by an issuer. The online transaction account is capable of storing tokens used over a network. An exchanging rule is previously provided and defines exchange between the transaction awards and the tokens. The system according to the invention includes a receiving module, an inquiring module and a processing module. The receiving module is for receiving a request information from the person. The request information indicates request of establishing the online transaction account and exchanging a predetermined amount of transaction awards within the transaction awards obtained by the person into tokens. The inquiring module is for generating an inquiry information based on the request information, and transmitting the inquiry information to the issuer. The processing module is for receiving from the issuer a response information responsive to the inquiry information through the inquiring module, and judging the response information to identify whether the transaction awards obtained by the person are valid. If the transaction awards obtained by the person are identified as being valid, the processing module also functions establishing the online transaction account on behalf of the person, exchanging the predetermined amount of transaction awards into tokens in accordance with the exchanging rule, and then storing the exchanged tokens into the established online transaction account.

### FIELD OF THE INVENTION

The present invention relates to a system and a method for establishing and processing an online transaction account capable of storing tokens used over a network such as a LAN, a WAN or an internet. More in particular, the invention relates to a system and a method for establishing and processing an online transaction account based on transaction awards obtained by a person and offered by an issuer.

### BACKGROUND OF THE INVENTION

There have been various kinds of transaction tools, such as credit card, co-branded credit card, debit card, chip card or smart card, used by people in daily purchase of goods or services. People usually use the transaction tools as convenient tools in payment, credit or transfer. When a customer holds one of the transaction tools and deals with a transaction through use of the hold transaction tool, an issuer, who issues the hold transaction tool, offers awards resulting from the transaction to the consumer for encouraging the customer to charge more. For example, an issuing bank, issuing a credit card, offers awards resulting from transactions to a customer who holds the credit card and deals with the transactions through use of the credit card.

Besides the issuers issuing the aforesaid transaction tools, current merchants, such as chain stores, supermarkets, discount retailers, gasoline stations, shopping malls, department stores, etc., would also issue membership cards or PIN cards for their clients. Just like the aforesaid transaction tools, most of these membership cards and PIN cards have corresponding accounts capable of collecting and accumulating transaction awards offered by the large merchants for encourage customer to charge more. Therefore, the term—“transaction tool” depicted hereinafter represents those tools that function collecting and accumulating awards resulting from transactions.

As the transaction tools become popular more and more, the issuers of the transaction tools all devote to proliferating award programs for encouraging customers to charge more. In general, the issuers offer specific gift-exchange programs to their customers. However, in conventional award programs, the specific gifts offered by issuers seldom are necessary for customers and seldom interests customers. Even though the award programs have been successful, the consumers are becoming aware that the award programs involve a considerable accumulation period to earn a benefit, have a ceiling and a deadline on the award, encourage consumers to charge excessively, or waste small amount of transaction awards. Therefore, the conventional award programs seldom are fair for customers and seldom benefits encouraging customers to charge more.

U.S. Pat. No. 6,018,718 is a resolution of the above-mentioned problem. The prior art analyses historical records of a holder corresponding to a transaction tool, makes, according to the historical records of the holder, an award program customized to the holder, and offers the customized award program to the holder. However, the prior art still limits the application range of the transaction awards obtained by the holder. That is, the holder can only exchange his transaction awards into goods or services purchased in real society. Accordingly, an objective of the invention is to provide a “fresh” award program which can make customers utilizing their transaction awards conveniently and certainly encourage customers to charge more.

Otherwise, by the blooming of various networks, more and more people are getting various goods or service over various networks. In the past, people must go to real stores to purchase the goods or services. Furthermore, there are new types of services provided to customers through networks, such as online games and digital contents. However, the market of online transaction doesn't grow as quickly as the networks do. As well known in arts, the security of network is a very important problem for the online transaction. In addition, how to encourage customers to consume over networks also retards the extension of online transaction. Accordingly, another objective of the invention is to provide a mechanism of exchanging transaction awards obtained from real society into tokens used over a network. Thereby, all of transaction awards obtained by a customer are available for the customer. This way, on one hand, can encourage customers to charge more in real society through use of original transaction tools, and on the other hand, encourage customer to consume over networks with less consideration of network security.

Besides, to eliminate the inconvenience of establishing an online transaction account for customer, another objective of the invention is to provide a system and a method for establishing and processing an online transaction account. Moreover, in particular, the system and method of the invention are based on transaction awards, obtained by a person and offered by an issuer, to establish the online transaction account and then to process the established online transaction account.

### SUMMARY OF THE INVENTION

An objective of the present invention is to provide a system and method for establishing and processing an online transaction account. The online transaction account is capable of storing tokens used over a network such as a LAN, a WAN or an internet. Moreover, in particular, the system and method according to the invention are based on transaction awards, obtained by a person and offered by an issuer, to establish the online transaction account and then to process the established online transaction account. Thereby, all of the transaction awards obtained by the persona are available for the person. This way, on one hand, can encourage the person to charge more in real society through use of a transaction tool issued by the issuer and corresponding to the online transaction account, and on the other hand, encourage the person to consume over the network.

According to a preferred embodiment of the invention, a data processing system is provided for establishing and processing an online transaction account based on transaction awards obtained by a person and offered by an issuer. The online transaction account is capable of storing tokens used over a network. An exchange rule is previously provided and defines exchange between the transaction awards and the tokens. The data processing system, according to the preferred embodiment of the invention, includes a receiving module, an inquiring module and a processing module. The receiving module is for receiving a request information from the person. The request information indicates request of establishing the online transaction account and exchanging a predetermined amount of transaction awards within the transaction awards obtained by the person into tokens. The inquiring module is for generating an inquiry information based on the request information, and transmitting the inquiry information to the issuer. After receiving the inquiry information, the issuer generates a response information responsive to the inquiry information. The processing module is for receiving from the issuer the response information responsive to the inquiry information through the inquiring module. The processing module judges the response information to identify whether the transaction awards obtained by the person are valid. If the transaction awards obtained by the person are identified as being valid, the processing module also functions establishing the online transaction account on behalf of the person, exchanging the predetermined amount of transaction awards into tokens in accordance with the exchanging rule, and then storing the exchanged tokens into the established online transaction account.

The objectives of the present invention will no doubt become obvious to those of ordinary skill in the art after reading the following detailed description of the preferred embodiment, which is illustrated in various figures and drawings.

### BRIEF DESCRIPTION OF THE APPENDED DRAWINGS

FIG. 1 is a schematic diagram showing the configuration of a data processing system 10 according to the preferred embodiment and an environment where the data processing system can be applied.

FIG. 2 is a flow chart illustrating a data processing method utilizing the data processing system 10.

### DETAILED DESCRIPTION OF THE INVENTION

The objective of the invention is to provide a data processing system and a data processing method for establishing and processing an online transaction account. The online transaction account is capable of storing tokens used over a network where the tokens represent all types of online consumption rights. Moreover, in particular, the system and method according to the invention are based on transaction awards, obtained by a person and offered by an issuer, to establish and the online transaction account and then to process the established online transaction account. Thereby, the person can make use of his transaction awards conveniently. Therefore, This invention can encourage the person to charge more through use of a transaction tool corresponding to the online transaction account and issued by the issuer. The invention can also encourage the person to consume over the network. In the following, the characteristic, advantage, and convenience of the present invention will be illustrated with the preferred embodiment of present invention.

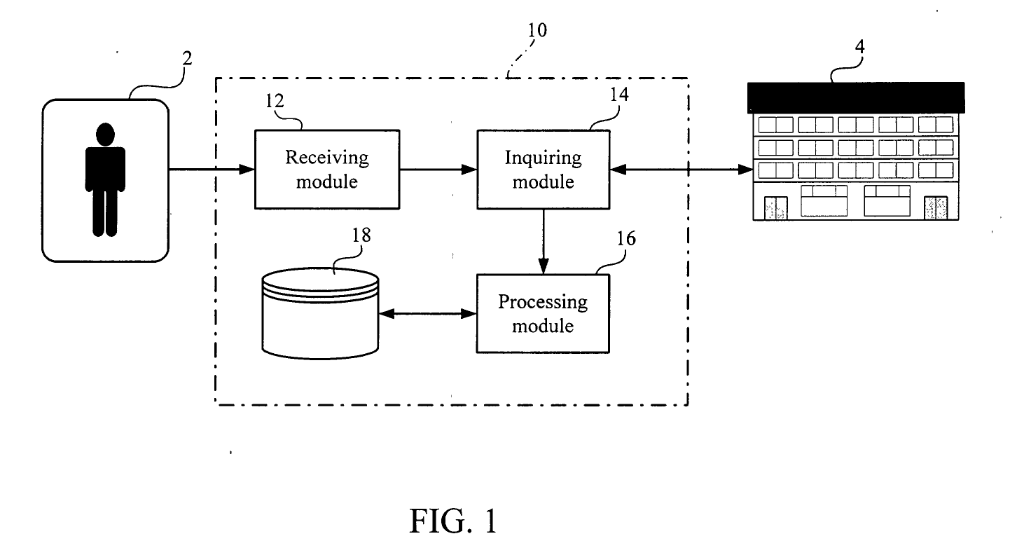

Referring to FIG. 1, FIG. 1 is a schematic diagram showing the configuration of a data processing system 10 according to a preferred embodiment and an environment where the data processing system can be applied. The data processing system 10 according to the embodiment of the invention communicates with a person 2 and an issuer 4 respectively. The data processing system 10 is based on transaction awards, obtained by the person 2 and offered by the issuer 4, to selectively establish the online transaction account 18, and then to process the online transaction account 18 if the online transaction 18 is established. The online transaction account 18 is capable of storing tokens used over a network such as a LAN, a WAN or an internet. An exchanging rule is previously provided and defines exchange between the transaction awards and the tokens.

According to the preferred embodiment of the invention, the data system 10 includes a receiving module 12, an inquiring module 14 and a processing module 16. The receiving module 12 functions receiving a request information from the person 2. The request information indicates request of establishing the online transaction account 18 and exchanging a predetermined amount of transaction awards within the transaction awards obtained by the person 2 into tokens. The inquiring module 14 functions generating an inquiry information based on the request information, and transmitting the inquiry information to the issuer 4. The inquiry information is used for identifying whether the transaction awards obtained by the person 2 are valid.

Here is an example for illustrating the content and the purpose of the inquiring information. For example, the transaction awards result from several transactions which the person 2 deals with through use of a credit card issued by an issuing bank, namely, the issuer 4 is the issuing bank. The issuing bank offers the transaction awards to the person 2 based on the several transactions. In this case, the inquiry information may include data associated with the person 2, data associated with the credit card thereof, data associated with the issuing bank, data associated with authorization of the transaction, or other data capable of being used to identify whether the transaction awards are valid.

After receiving the inquiry information, the issuer 4 generates a response information responsive to the inquiry information, and sends out the response information to the system 10. The processing module 16 functions receiving from the issuer 4 the response information responsive to the inquiry information through the inquiring module 14. The processing module 16 also functions judging the response information to identify whether the transaction awards are valid. When the transaction awards obtained by the person 2 are identified as being valid, the processing module 16 also functions establishing the online transaction account 18 on behalf of the person 2, and at this time, the online transaction account 18 just exists. On the contrary, when the transaction awards are identified as being invalid according to the response information, the processing module 16 doesn't establish the online transaction account 18.

If the online transaction account 18 is established, the processing module 16 alos functions exchanging the predetermined amount of transaction awards into tokens, and then storing the exchanged tokens into the established online transaction account 18.

In one embodiment, the online transaction account 18 is set up in the data processing system 10. That is, the data processing system 10 functions managing the online transaction account 18, as showed in FIG. 1. In another embodiment, the online transaction account 18 is set up outside the data processing system 10. That is, the online transaction account 18 is managed by an organization which provides the online transaction account 18.

In one embodiment, the transaction awards result from transactions made by the person 2 through use of a transaction tool issued by the issuer 4. The transaction tool can be a credit card, a co-branded credit card, a PIN card, a debit card, an Chip card, a smart card, a membership card, or the like that functions collecting and accumulating awards resulting from transactions. In one embodiment, the transaction tool has a management account for storing the transaction awards obtained by the person 2.

In order to make the person 2 remember easily the account number of the established online transaction account 18, in one embodiment, the management account of the transaction tool has a first account number, and the online transaction account has a second account number. Moreover, the second account number is equal to the first account number.

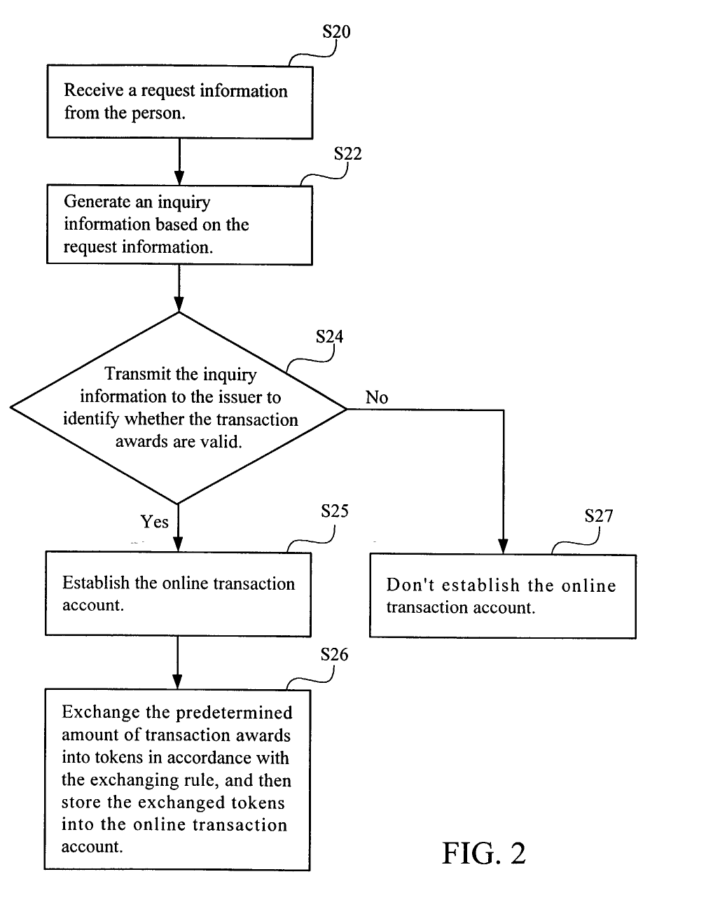

As follows will illustrate a data processing method utilizing the data processing system 10 according to the preferred embodiment of the invention. Referring to FIG. 2, first, the data processing method performs step S20 to receive from the person 2 a request information indicative of request of establishing the online transaction account 18 and exchanging a predetermined amount of transaction awards within the transaction awards into tokens.

After step S20, step S22 is performed to generate an inquiry information based on the request information. Then, step S24 is performed to transmit the inquiry information to the issuer 4 to identify whether the transaction awards are valid. If “No” in step S24, namely, the transaction awards are identified as being invalid, step S27 is performed. In step S27, establishing of the online transaction account 18 is rejected.

If Yes in step S24, namely the transaction awards are identified as being valid, step S25 is performed to establish the online transaction account 18 on behalf of the person 2, and at this time, the online transaction account 18 just exists. After step S24, step S25 is performed to exchange the predetermined amount of transaction awards into tokens in accordance with the exchanging rule, and then to store the exchanged tokens into the established online transaction account 18.

The distinct features and advantages of this present invention are listed as the following:

(a) by exchanging the transaction awards obtained in real society into tokens used over a network, effectively combining the consumption resource in real society and the consumption resource in the network,;

(b) by making customers use transaction awards conveniently, encourage the customers to charge more through use of transaction tools functioning collecting and accumulating the transaction awards; and

(c) by offering a convenient online consumption mode with less consideration of the network security to customers, encourage the customers to consume over the network.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system for establishing and processing an online transaction account based on transaction awards obtained by a person and offered by an issuer, said online transaction account being capable of storing tokens used over a network, an exchanging rule being previously provided and defining exchange between the transaction awards and the tokens, said system comprising:
a receiving module for
receiving from said person a request information indicative of establishing said online transaction account and exchanging a predetermined amount of transaction awards within the transaction awards obtained by said person into tokens;
an inquiring module for
generating an inquiry information based on the request information, and
transmitting the inquiry information to said issuer;
a processing module for
receiving from said issuer a response information responsive to the inquiry information through said inquiring module,
judging the response information to identify whether the transaction awards obtained by said person are valid, and
when the transaction awards obtained by said person are identified as being valid, establishing said online transaction account on behalf of said person, exchanging the predetermined amount of transaction awards into tokens in accordance with the exchanging rule, and storing the exchanged tokens into said established online transaction account.

2. The data processing system of claim 1, wherein the transaction awards result from transactions made by said person through use of a transaction tool issued by said issuer.

3. The data processing system of claim 2, wherein the transaction tool is one selected from the group consisting of a credit card, a co-branded credit card, a PIN card, a debit card, a chip card, a smart card and a membership card.

4. The data processing system of claim 3, wherein the transaction tool has a management account for storing the transaction awards obtained by said person.

5. The data processing system of claim 4, wherein the management account has a first account number, said online transaction account has a second account number, and the second account number is equal to the first account number.

6. A data processing method for establishing and processing an online transaction account based on transaction awards obtained by a person and offered by an issuer, said online transaction account being capable of storing tokens used over a network, a exchanging rule being previously provided and defining exchange between the transaction awards and the tokens, said method comprising the steps of:
(a) receiving from said person a request information indicative of establishing said online transaction account and exchanging a predetermined amount of transaction awards within the transaction awards obtained by said person into tokens;
(b) generating an inquiry information based on the request information;
(c) transmitting the inquiry information to said issuer to identify whether the transaction awards obtained by said person are valid;
(d) if YES in step (c), establishing said online transaction account on behalf of said person, exchanging the predetermined amount of transaction awards into tokens in accordance with the exchanging rule, and storing the exchanged tokens into said online transaction account.

7. The data processing method of claim 6, wherein the transaction awards result from transactions made by said person through use of a transaction tool issued by said issuer.

8. The data processing method of claim 7, wherein the transaction tool is one selected from the group consisting of a credit card, a co-branded credit card, a PIN card, a debit card, a chip card, a smart card and a membership card.

9. The data processing method of claim 8, wherein the transaction tool has a management account for storing the transaction awards.

10. The data processing method of claim 9, wherein the management account has a first account number, said online transaction account has a second account number, and the second account number is equal to the first account number.
